(19) United States
(12) Patent Application Publication
(10) Pub. No.: US 2025/0131087 A1
(43) Pub. Date: Apr. 24, 2025

(54) METADATA PROCESSING TECHNIQUES AND ARCHITECTURES FOR DATA PROTECTION

(71) Applicant: QUANTUM STAR TECHNOLOGIES INC., Coeur d'Alene, ID (US)

(72) Inventors: Timothy Wolverton SCHOCH, Chicago, IL (US); Henry STOLTENBERG, Folsom, CA (US)

(21) Appl. No.: 18/918,456

(22) Filed: Oct. 17, 2024

Related U.S. Application Data
(60) Provisional application No. 63/591,750, filed on Oct. 19, 2023.

(51) Int. Cl. G06F 21/56; G06F 21/64

(52) U.S. Cl. CPC G06F 21/562; G06F 21/64; G06F 2221/034

(57) ABSTRACT

Techniques and architectures for generating and/or providing intelligent data regarding potential data issues are discussed herein. For example, the techniques can include processing data that is associated with a potential issue using a hash-based technique to create a signature for the data. The processing can include processing the data in groups of bytes with each group of bytes including a predetermined number of bytes. The techniques can also include comparing the signature to a signature for data that is labeled as being associated with an issue and determining a matched signature based on the comparing. Further, the techniques can include retrieving metadata for the signature for the data that is labeled as being associated with the issue. The metadata can indicate a characteristic of the issue. The techniques can then provide analysis data indicating that the data is associated with the characteristic.

### CROSS-REFERENCE TO RELATED APPLICATIONS

This application claims priority to U.S. Provisional Application No. 63/591,750, filed Oct. 19, 2023, and entitled “Metadata Processing Techniques and Architectures for Data Protection,” the entire contents of which are incorporated herein by reference.

### BACKGROUND

Anti-malware tools are implemented to prevent, detect, and remove malware that threatens computing devices. These tools use pattern matching, heuristic analysis, behavioral analysis, or hash matching to identify malware. Although these techniques provide some level of security, the anti-malware tools are slow to adapt to changing malware, reliant on humans to flag or verify malware, slow to process data, and provide limited information regarding a detected threat. This often leaves computing devices exposed to malware for relatively long periods of time, causing various undesirable issues.

### BRIEF DESCRIPTION OF THE DRAWINGS

Various examples are depicted in the accompanying drawings for illustrative purposes. In addition, various features of different disclosed examples can be combined to form additional examples, which are part of this disclosure. In the figures, the left-most digit(s) of a reference number identifies the figure in which the reference number first appears. Throughout the drawings, reference numbers can be reused to indicate correspondence between reference elements.

FIG. 1 illustrates an example architecture in which the techniques described herein can be implemented.

FIG. 2 illustrates an example process to detect a potential issue with data and generate/provide information regarding the issue.

FIG. 3 illustrates an example process to generate a signature for data.

FIG. 4 illustrates an example process to compare a signature for input data to signatures for data that is associated with an issue/threat and to obtain metadata associated with a matched signature.

FIG. 5 illustrates an example process to generate clusters for data items and classify the clusters.

FIG. 6 illustrates an example process to compare a signature for input data to signatures associated with a cluster and to obtain metadata associated with a matched signature.

### DETAILED DESCRIPTION

This disclosure describes techniques and architectures for generating and/or providing intelligent data regarding potential data issues, such as threats, interruptions, nuisances, vulnerabilities, etc. For example, the techniques and architectures can process data at a bit/byte level to determine that the data is associated with a potential security threat and/or analyze the data at the bit/byte level using one or more hashing-based techniques. For instance, the data that is identified as potentially including a threat can be interpreted as a predetermined data type, which can be different than the data type initially intended for the data. The data can be interpreted with a predetermined number of bits/bytes corresponding to a certain representation. For example, the data can be interpreted with a predetermined number of bits/bytes representing a character and a predetermined number of characters forming a word, even if the data was not initially generated/stored/provided for interpretation as characters/text and/or if the data was text data with words having other or random lengths of characters. One or more hashing-based techniques can then be used to convert the characters into a data signature. The data signature can be compared to data signatures of threat data that are associated with different types of data security issues. If a matched signature is identified (e.g., satisfying one more criteria), metadata for the threat data can be retrieved and used to generate a notification/message regarding the data. This metadata and/or notification can indicate a category/classification of the issue/threat, an entity that created the issue/threat, an entity that distributed the issue/threat, a time/date when the issue/threat was created/updated, a platform targeted by the issue/threat, a behavior/function of the issue threat, a method/technique used to propagate/transmit the issue/threat, and/or any other characteristic of the issue/threat. The metadata and/or notification can be provided to various systems and/or users, such as information technology users, consumers, etc., to provide intelligent insights about the data. In examples, an operation can be performed based on the metadata and/or notification to address a potential security issue, such as removing a threat, ensuring that the threat is not associated with the data, providing a notification/message regarding the threat, or another operation.

In examples, the techniques and architectures discussed herein can consume less computational time and/or less computational resources, in comparison to other techniques. For instance, by comparing a signature of input data with signatures of data associated with an issue/threat, the techniques can avoid comparing complete data sets. Further, by comparing signature bands, in some cases as discussed herein, the techniques can efficiently compare input data to data that is associated with an issue/threat.

A data issue or potential data issue can refer to/include malicious behavior (e.g., malicious data intended to damage an environment/system/device), benign behavior (e.g., data/behavior that is not malicious, but can be an issue), a vulnerability (e.g., vulnerability data that can make an environment/system/device vulnerable to an attack), or any other security-related characteristic that can potentially pose a threat, interruption, nuisance, vulnerability, etc. For ease of discussion, data issues will often be referred to as a threat or data threat. However, the techniques and architectures are applicable to any type of data issue.

A threat (sometimes referred to as “malicious data”) can include malware, phishing, a rootkit, a bootkit, a logic bomb, a backdoor, a screen scraper, a physical threat (e.g., an access point without security measures, such as leaving a door open, etc.), and so on. Malware can include a virus, spyware, adware, a worm, a Trojan horse, scareware, ransomware, polymorphic malware, and so on. In examples, a threat results from data, software, or another component that has malicious intent. In some examples, detecting a physical threat includes processing data representing a physical environment, such as images of the interior or exterior of a building. The potential physical threat can include an access point that can potentially be at risk of a break-in due to reduced security features at the access point.

Although certain examples are disclosed herein, the disclosure extends beyond the specifically disclosed examples to other alternative examples and/or uses, and to modifications and equivalents thereof. For example, in any method or process disclosed herein, the acts or operations of the method or process can be performed in any suitable sequence and are not necessarily limited to any particular disclosed sequence. Various operations can be described as multiple discrete operations in turn, in a manner that can be helpful in understanding certain examples; however, the order of description should not be construed to imply that these operations are order dependent. Additionally, the structures, systems, and/or devices described herein can be embodied as integrated components or as separate components. For purposes of comparing various examples, certain aspects of these examples are described. Not necessarily all such aspects are achieved by any particular example. For example, various examples can be carried out in a manner that achieves or optimizes one feature or group of features as described herein without necessarily achieving other aspects as can also be described or suggested herein.

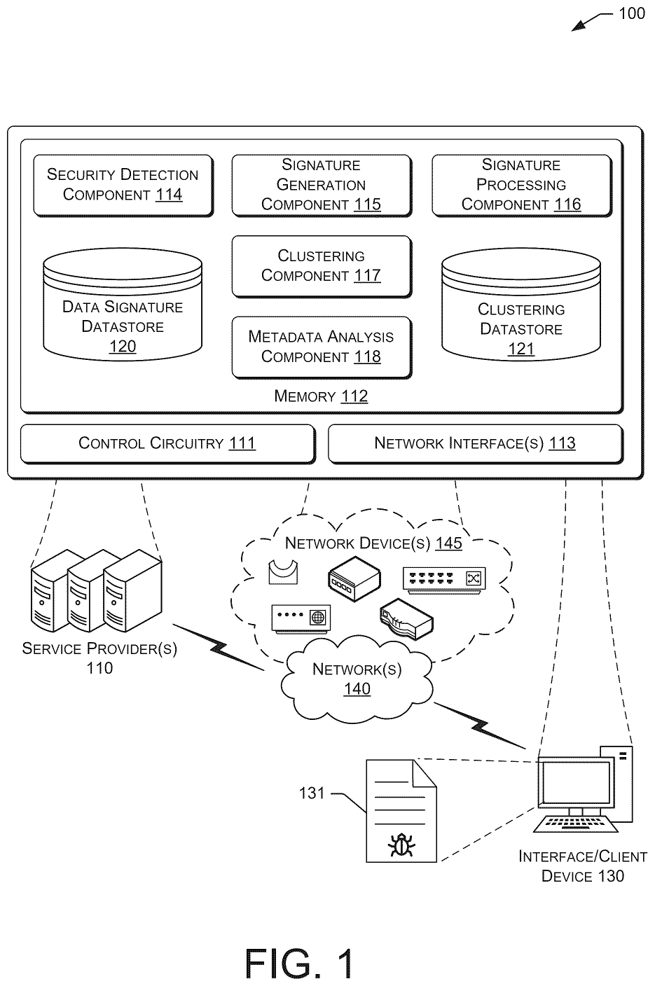

FIG. 1 illustrates an example architecture 100 in which the techniques described herein can be implemented. The architecture 100 includes one or more service providers 110 (also referred to as “the service provider 110,” for ease of discussion) configured to communicate with one or more interface/client devices 130 (also referred to as “the client device 130,” for ease of discussion) over one or more networks 140 (also referred to as “the network 140,” for ease of discussion). For example, the service provider 110 can perform processing remotely/separately from the client device 130 and/or communicate with the client device 130 to facilitate such processing for the client device 130 and/or another device. The service provider 110 and/or the client device 130 can be configured to facilitate various functionality. As shown, the network 140 can include one or more network devices 145 (also referred to as “the network device 145,” for ease of discussion) to facilitate communication over the network 140. The service provider 110, the client device 130, and/or the network device 145 can be configured to perform any of the techniques/functionality discussed herein, which can process data to detect an issue, provide information regarding the issue, etc. Although example devices are illustrated in the architecture 100, any of such devices can be eliminated/not implemented. In one example, the service provider 110 can implement the techniques discussed herein without communicating with the client device 130 and/or without using the network 140. In another example, the client device 130 can implement the techniques without communicating with the service provider 110 and/or without using the network 140. In yet another example, the network device 145 can implement the techniques with or without communicating with another device.

The service provider 110 can be implemented as one or more computing devices, such as one or more servers, one or more desktop computers, one or more laptops computers, or any other type of device configured to process data. In some examples, the one or more computing devices are configured in a cluster, data center, cloud computing environment, or a combination thereof. In some examples, the one or more computing devices of the service provider 110 are implemented as a remote computing resource that is located remotely to the client device 130. In other examples, the one or more computing devices of the service provider 110 are implemented as local resources that are located locally at the client device 130.

The client device 130 can be implemented as one or more computing devices, such as one or more desktop computers, laptops computers, servers, smartphones, electronic reader devices, mobile handsets, personal digital assistants, portable navigation devices, portable gaming devices, tablet computers, wearable devices (e.g., a watch, ring, etc.), portable media players, televisions, set-top boxes, computer systems in a vehicle, appliances, cameras, security systems, home-based computer systems, projectors, and so on. In examples, the client device 130 and/or the network device 145 is an internet-of-things (IoT) device.

In examples, the client device 130 includes one or more input/output (I/O) components, such as one or more displays, microphones, speakers, keyboards, mice, cameras, and so on. The one or more displays can be configured to display data associated with aspects of the present disclosure. For example, the one or more displays can be configured to present a graphical user interface (GUI) to facilitate operation of the client device 130, present information associated with an evaluation of data (e.g., information indicating if a potential threat is detected), present information regarding a potential issue (e.g., metadata for a potential threat, such as metadata for data that has a threshold amount of similarity to data under analysis), provide input to cause an operation to be performed to address an issue (e.g., an operation to have a threat removed, prevent a threat from associated with and/or further corrupting data, prevent a threat from being stored with data, etc.), and so on. The one or more displays can include a liquid-crystal display (LCD), a light-emitting diode (LED) display, an organic LED display, a plasma display, an electronic paper display, or any other type of technology. In some examples, the one or more displays include one or more touchscreens and/or other user input/output (I/O) devices.

The network device 145 can include one or more routers, bridges, switches, repeaters, modems, gateways, hubs, wireless access points, servers, network interface controllers, or any other device/hardware configured to facilitate reception/transmission of data from/to another component.

As shown, the service provider 110, client device 130, and/or network device 145 can include control circuitry 111, memory 112, and/or one or more network interfaces 113 configured to perform functionality described herein and/or other functionality. For ease of discussion and illustration, the control circuitry 111, memory 112, and one or more network interfaces 113 are shown with one set of blocks representing the individual components. However, in examples, the service provider 110, client device 130, and/or network device 145 can each include separate instances of the control circuitry 111, memory 112, and network interface 113. For example, the service provider 110 can include its own control circuitry, data storage/memory, and/or network interface (e.g., to implement processing on the service provider 110), the network device 145 can include its own control circuitry, data storage/memory, and/or network interface (e.g., to implement processing on the network device 145), and/or the client device 130 can include its own control circuitry, data storage/memory, and/or network interface (e.g., to implement processing on the client device 130). As such, reference herein to control circuitry/memory can refer to circuitry/memory embodied in the service provider 110, client device 130, and/or network device 145.

Although the control circuitry 111 is illustrated as a separate component from the memory 112 and network interface 113, the memory 112 and/or the network interface 113 can be embodied/included in at least in part in the control circuitry 111. For instance, the control circuitry 111 can include various devices (active and/or passive), semiconductor materials and/or areas, layers, regions, and/or portions thereof, conductors, leads, vias, connections, and/or the like, wherein one or more of the memory 112 and the network interface 113 and/or portion(s) thereof can be formed and/or embodied at least in part in/by such circuitry components/devices.

The control circuitry 111 can include one or more processing modules/units, chips, dies (e.g., semiconductor dies including come or more active and/or passive devices and/or connectivity circuitry), microprocessors, micro-controllers, digital signal processors (DSPs), microcomputers, central processing units (CPUs), graphics processing units (GPUs), programmable logic devices, state machines (e.g., hardware state machines), logic circuitry, analog circuitry, digital circuitry, application specific integrated circuits (ASICs), field-programmable gate arrays (FPGAs), program-specific standard products (ASSPs), complex programmable logic devices (CPLDs), and/or any device that manipulates signals (analog and/or digital) based on hard coding of the circuitry and/or operational instructions. In examples, the control circuitry includes or is referred to as one or more processors or processing circuitry. Control circuitry can further comprise one or more storage devices, which can be embodied in a single memory device, a plurality of memory devices, and/or embedded circuitry of a device. Such data storage can comprise read-only memory, random access memory, volatile memory, non-volatile memory, static memory, dynamic memory, flash memory, cache memory, data storage registers, and/or any device that stores digital information. In some examples in which control circuitry comprises a hardware state machine (and/or implements a software state machine), analog circuitry, digital circuitry, and/or logic circuitry, data storage device(s)/register(s) storing any associated operational instructions can be embedded within, or external to, the circuitry comprising the state machine, analog circuitry, digital circuitry, and/or logic circuitry.

The memory 112 (as well as any other memory discussed herein) can include any suitable or desirable type of computer-readable media. For example, one or more computer-readable media can include one or more volatile data storage devices, non-volatile data storage devices, removable data storage devices, and/or nonremovable data storage devices implemented using any technology, layout, and/or data structure(s)/protocol, including any suitable or desirable computer-readable instructions, data structures, program modules, or other data types. One or more computer-readable media that can include, but is not limited to, phase change memory, static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other medium that can be used to store information for access by a computing device. As used in certain contexts herein, computer-readable media may not generally refer to communication media, such as modulated data signals and carrier waves. As such, computer-readable media generally refers to non-transitory media.

The control circuitry 111, memory 112, and/or network interface 113 can be electrically and/or communicatively coupled using certain connectivity circuitry/devices/features, which may or may not be part of control circuitry 111. For example, the connectivity feature(s) can include one or more printed circuit boards configured to facilitate mounting and/or interconnectivity of at least some of the various components/circuitry. In some examples, two or more of the components can be electrically and/or communicatively coupled to each other.

The memory 112 can store a security detection component 114, signature component 115, signature processing component 116, clustering component 117, and metadata analysis component 118, which can include executable instructions that, when executed by the control circuitry 111, cause the control circuitry 111 to perform various operations discussed herein. For example, one or more of the components 114-118 can include software/firmware modules. However, one or more of the components 114-118 can be implemented as one or more hardware logic components, such as one or more application specific integrated circuits (ASIC), field-programmable gate arrays (FPGAs), program-specific standard products (ASSPs), complex programmable logic devices (CPLDs), and/or the like. For ease of discussion, the components 114-118 are illustrated as separate components. However, one or more of the components 114-118 can be implemented as any number of components to implement the functionality discussed herein (e.g., combined or separated into additional components).

The security detection component 114 can be configured to detect a potential issue with data (sometimes referred to as “input data”). For example, the security detection component 114 can represent data with one or more n-dimensional representations and/or use one or more analysis models to identify a characteristic(s) of the one or more n-dimensional representations. To generate an n-dimensional representation, the security detection component 114 can represent groups of bits within the data as points within a coordinate system, with a set of bits within a group of bits representing a coordinate for a point. The security detection component 114 can use the points (e.g., point cloud, values associated with the points, etc.) as the n-dimensional representation and/or generate a model (e.g., a mesh, wireframe, etc.) or another representation based on the points. The security detection component 114 can then analyze the n-dimensional representation to determine if there is a potential issue with the data. In one example, the security detection component 114 can compare the n-dimensional to other n-dimensional representations that have been tagged as being associated with issues/threats. Additionally, or alternatively, the security detection component 114 can use an artificial intelligence model (e.g., neural network) that has been trained to detect issues/threats to determine if there is a potential issue/threat with the data. In some instances, the security detection component 114 uses one or more of the techniques discussed in U.S. application Ser. No. 16/569,978 (filed Sep. 13, 2019) and U.S. application Ser. No. 17/185,884 (filed Feb. 25, 2021), which are hereby incorporated by reference in their entirety.

To illustrate generation of an n-dimensional representation, the security detection component 114 can process data at a bit/byte level, such as by processing the data in groups of bits with each group of bits being converted to a coordinate for a point. For example, the security detection component 114 can convert a first group of bits (e.g., a first byte) into an x-coordinate value, a second group of bits (e.g., a second adjacent byte) into a y-coordinate value, and a third group of bits (e.g., a third adjacent byte) into a z-coordinate value. The three coordinate values can produce/represent a point within a coordinate system (e.g., position of the point). That is, the first group of bits can represent an x-coordinate (e.g., x-value from 0 to 255 on a coordinate system), the second group of bits can represent a y-coordinate for the point (e.g., y-value from 0 to 255 on the coordinate system), and the third group of bits can represent z-coordinate for the point (e.g., z-value from 0 to 255 on the coordinate system). The security detection component 114 can process any number of bits (e.g., groups of bits) in the data in a similar fashion to produce any number of points within the coordinate system. Although this illustration is in the context of generating three values for a three-dimensional (3D) space, an n-dimensional representation can include any number of dimensions for a n-dimensional space.

In some examples, points produced by such process form an n-dimensional representation (e.g., a point cloud, values of the point cloud, etc.). Further, in some examples, points produced by such process can be used to form an n-dimensional representation. For instance, the security detection component 114 can use a pattern recognition algorithm to identify a set of points that are associated with a particular characteristic(s). Such pattern recognition algorithm can generally seek to identify points that are within a particular distance from each other, positioned to form a virtual surface/plane, and/or otherwise include characteristics that can indicate that the set of points can form a surface/plane. The security detection component 114 can generate an n-dimensional representation based on the set of points, such as a 2D model, 3D model, or n-D model. In examples, a model is a polygon mesh that includes one or more vertices, edges, faces, polygons, surfaces, and so on. Further, in examples, a model is a wire-frame model that includes one or more vertices, edges, and so on. However, other types of models can be implemented. Further, the representation generation component 115 can generate other types of n-dimensional representations, such as an n-dimensional map.

To illustrate an analysis of an n-dimensional representation, the security detection component 114 can use one or more analysis models to generate a confidence value/data indicating a likelihood that an n-dimensional includes an issue. In examples, the security detection component 114 can determine that an n-dimensional representation includes a potential issue if a confidence value is above a threshold (or below a threshold, in some cases). In some instances, the security detection component 114 is configured to compare an n-dimensional representation to one or more n-dimensional representations that have been tagged as having an issue. For example, a 2D or 3D model for data can be compared to 2D or 3D models for malicious data to determine a similarity of the 2D or 3D data model to the 2D or 3D malicious data models. Here, the security detection component 114 can be configured to compare a similarity between surfaces, edges, volume, area, and/or any other characteristic of a model. Further, in some instances, the security detection component 114 can use an Artificial Intelligence (AI) model that is trained to detect one or more characteristics of data that is associated with an issue/threat. For example, the security detection component 114 can use pattern recognition, feature detection, shape/surface detection, and/or a spatial analysis to identify one or more characteristics of an n-dimensional representation and/or patterns of the one or more characteristics. The security detection component 114 can determine if the one or more characteristics are associated with a potential issue/threat for the data.

In examples, the security detection component 114 can be configured to select a portion of data to process. For example, the security detection component 114 can select a number of bits/bytes of data and/or a particular portion of the data, such as a predetermined number of bits/bytes (e.g., 1500 bits/bytes, 15,0000 bits/bytes, 500 bits/bytes, and so on), header/footer/body data, metadata, a particular number of bits/bytes within a particular portion the data, and so on. In examples, the security detection component 114 can determine a type of the data (e.g., file system data, network traffic data, runtime data, non-image-based data, data stored in volatile memory, data stored in non-volatile memory, behavioral data, and so on) and select a particular portion of the data and/or a number of bits/bytes based on the type of data. For instance, it can be determined through machine learning or other techniques that evaluating a particular section of data (e.g., a header, a footer, a section of a payload, etc.) for a particular type of data accurately detects threats associated with the type of data by more than a threshold (e.g., 99% of the time). As such, the security detection component 114 can select the particular section within each piece of data (e.g., file) and refrain from selecting other sections of the piece of data.

To illustrate, the security detection component 114 can process a portion of data while refraining from processing another portion of the data (or at least initially refraining from processing the other portion). For example, the security detection component 114 can process a predetermined number of bytes of each file, such as a first 1500 bytes of each file, a second 1500 bytes of each file, or a last 1500 bytes of each file, to generate an n-dimensional representation for each file. In some examples, an initial portion of data (e.g., a file) can include a header that designates execution points within the data. In cases where malware or other threats are associated with a header and/or execution points, which can frequently be the case, the representation the security detection component 114 can efficiently process data by generating an n-dimensional representation based on the data within the header.

An n-dimensional representation can include a variety of representations, such as an n-dimensional point cloud or other plurality of points, an n-dimensional map, an n-dimensional model (e.g., mesh model, wireframe model, etc.), and so on. The term “n” can represent any integer. In some examples, an n-dimensional representation can include surfaces, vertices, corners, edges, etc. In some examples, an n-dimensional representation can be visualized by a human, while in other examples an n-dimensional representation may not able to be visualized by a human. In some examples, data representing an n-dimensional representation (e.g., coordinates of points, surfaces, edges, corners, vertices, etc.) can be stored in an array, matrix, list, or any other data structure.

In examples, an n-dimensional representation can be represented within a coordinate system. A coordinate system can include a number line, a cartesian coordinate system, a polar coordinate system, a homogeneous coordinate system, a cylindrical or spherical coordinate system, etc. Although some examples are discussed herein in the context of two- or three-dimensional representations represented in two- or three-dimensional coordinate systems, the techniques and architectures can generate a representation of any number of dimensions and/or a representation can be represented in any type of coordinate system.

Data can include audio data, video data, text data (e.g., text files, email, etc.), binary data (e.g., binary files), image data, network traffic data (e.g., data protocol units exchanged over a network, such as segments, packets, frames, etc.), file system data (e.g., files), runtime data (e.g., data generated during runtime of an application, which can be stored in volatile memory), data stored in volatile memory, data stored in non-volatile memory, application data (e.g., executable data for one or more applications), data associated with an isolated environment (e.g., data generated or otherwise associated with a virtual machine, data generated or otherwise associated with a trusted execution environment, data generated or otherwise associated with an isolated cloud service, etc.), metadata, behavioral data (e.g., data describing behaviors taken by a program during runtime), location data (e.g., geographical/physical location data of a device, user, etc.), quality assurance data, financial data, financial analytics data, healthcare analytics data, and so on. Data can be formatted in a variety of manners and/or according a variety of standards. In some examples, data includes a header, payload, and/or footer section. Data can include multiple pieces of data (e.g., multiple files or other units of data) or a single piece of data (e.g., a single file or another unit of data). In some examples, data includes non-image-based data, such as data that is not initially intended/formatted to be represented within a coordinate system (e.g., not stored in a format that is intended for display). In contrast, image-based data can generally be intended/formatted for display, such as images, 2D models, 3D models, point cloud data, and so on. In some examples, a type of data can be defined by or based on a format of the data, a use of the data, an environment in which the data is stored or used (e.g., an operating system, device platform, etc.), a device that generated the data, a size of the data, an age of the data (e.g., when the data was created), and so on.

The signature generation component 115 can be configured to process data using one or more hash-based techniques to generate a signature for the data. In examples, the signature generation component 115 can generate a signature for data under analysis (also referred to as “input data”) and/or for data that is tagged/labeled as being associated with an issue/threat (which can be performed before analysis operations are performed). The one or more hash-based techniques can include operations associated Locality Sensitive Hashing (LSH), etc. A signature for data (also referred to as a “data signature”) can be stored in a data signature datastore 120 (e.g., a database, repository, etc.).

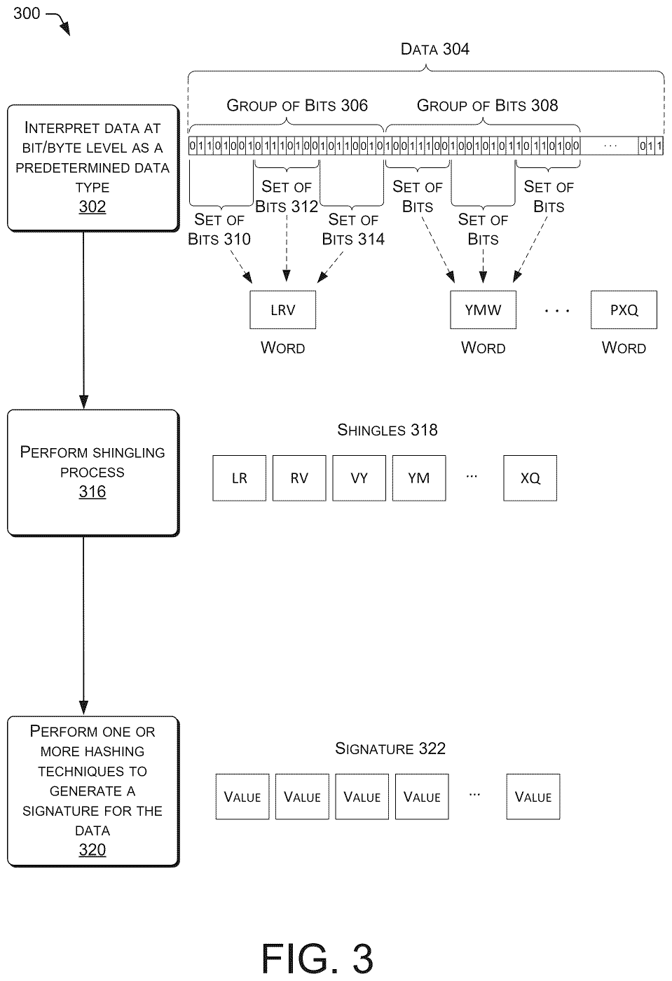

In some examples, the signature generation component 115 can interpret/process data as a predetermined data type and/or interpret/process the data in groups of bits/bytes that have a predetermined number of bits/bytes. For instance, input data can be interpreted with a predetermined number of bits/bytes representing a character and/or a predetermined number of characters forming a word, even if the data was not initially generated/stored/provided for interpretation as characters/text (e.g., non-character data type) and/or if the data was character data with words having random lengths of characters. Such interpretation/processing can allow the signature generation component 115 to generate a signature for the input data (e.g., in a format that is understood by a particular type of hashing algorithm/technique) without losing information about the data (e.g., avoid data loss, degradation, etc.). In examples, interpreting/processing data can include encoding/decoding, converting, translating, or otherwise manipulating/interpreting data in one format/type/standard in another format/type/standard. For instance, network data that has a network-based format for communication can be interpreted in a text/character format (e.g., American Standard Code for Information Interchange (ASCII), etc.). Example techniques for generating a signature(s) are discussed in further detail below in reference to FIG. 3.

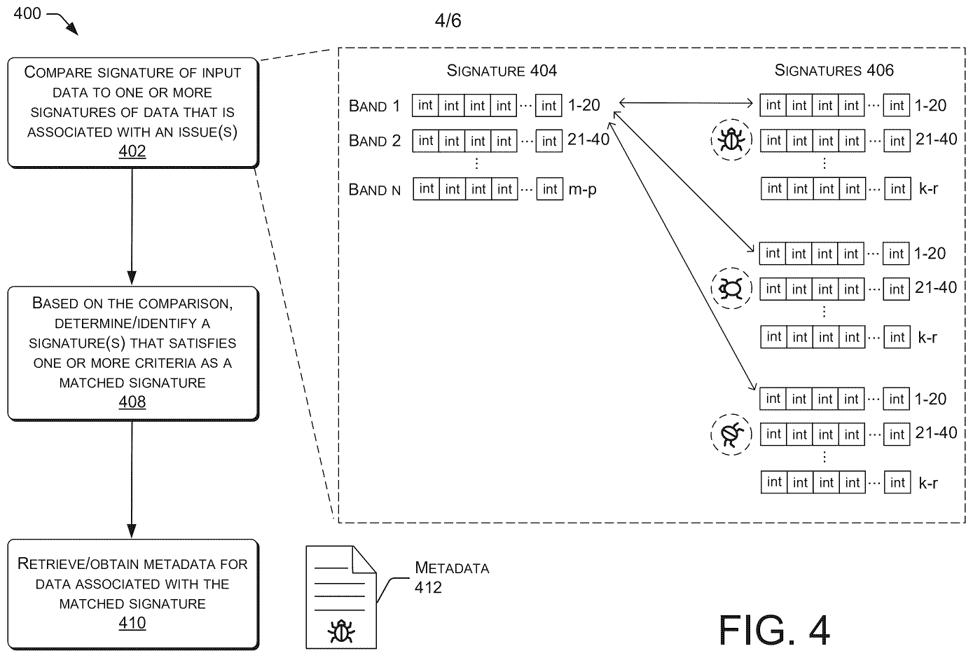

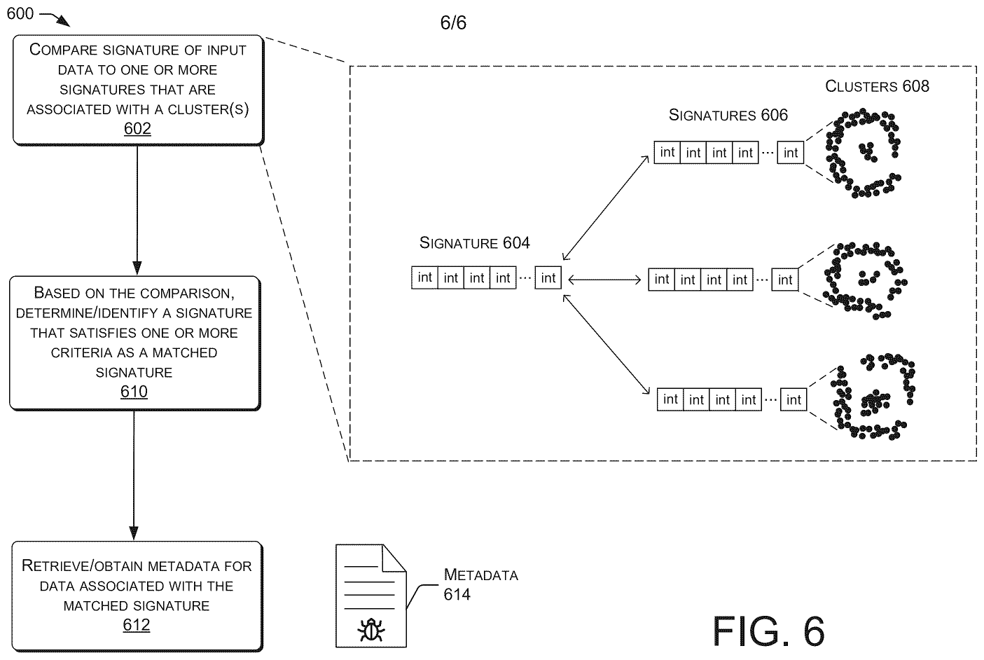

The signature processing component 116 can be configured to analyze/process a signature of data, such as by comparing the signature to one or more other signatures to determine if the signature is similar to another signature. For example, the signature processing component 116 can compare a data signature to one or more other data signature that are classified/tagged as being associated with an issue/threat to determine if the data signature has a particular/threshold amount of similarity to another data signature. The comparison can generate a similarity value/score and determine if the similarity value/score is above (or below, in some cases) a threshold. In examples, the signature processing component 116 can compare data signatures band-by-band to determine a similarity. A band of a signature can represent/include a predetermined number of bits/bytes/values of the signature. In some instances, the signature processing component 116 can implement one or more nearest neighbor techniques to determine a similarity between one or more data signatures. Example nearest neighbor techniques are discussed below in reference to FIG. 4. Further, in some instances, the signature processing component 116 can implement one or more clustering comparison techniques to determine a similarity between one or more data signatures. Example cluster comparison techniques are discussed below in reference to FIG. 6.

To illustrate, the signature processing component 116 can receive/retrieve a data signature (e.g., for data under analysis) from the signature generation component 115 and/or the data signature datastore 120 and compare the data signature to one or more other data signatures that are associated with an issue/threat. The one or more other data signatures can be stored in the data signature datastore 120 and/or classified/tagged/labeled as being associated with an issue/threat. The signature processing component 116 can compare a first band of the data signature to a first band of one or more other data signatures to determine if the first band satisfies one or more criteria, such as an exact match, match a certain number of bits/bytes, etc. Similarly, the signature processing component 116 can compare a second band of the data signature to a second band of the one or more other data signatures to determine if the second band satisfies one or more criteria. The signature processing component 116 can compare any number of bands to each other. In some instances, a matched signature can be found/identified when a predetermined number of bands are similar/match. Further, in some instances, the signature processing component 116 can refrain from processing any remaining bands of a data signature when a predetermined number of bands are compared and matched. The signature processing component 116 can identify one or more matched/similar signatures.

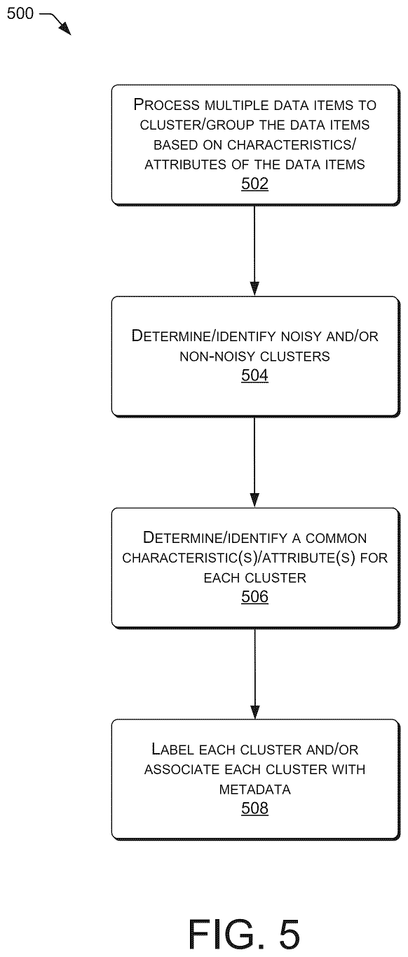

The clustering component 117 can be configured to generate/create/form one or more clusters for data associated with an issue(s) (e.g., training data). For example, the clustering component 117 can process data (e.g., multiple data pieces/files) that are tagged/labeled as being associated with threats to group/cluster the data into multiple groups/clusters. The clustering component 117 can analyze/compare/process attributes/characteristics of the data in an attempt to group/cluster data that has one or more similar/same attributes/characteristics into the same group/cluster. In some instances, clusters can be formed during a pre-processing phase/period of time, such as before runtime of one or more operations of the components 114-118 (e.g., before analyzing input data to determine if the input data is associated with a potential issue). The clustering component 117 can use a clustering algorithm/technique, such as a density-based clustering algorithm/model (e.g., Density-based spatial clustering of applications with noise (DBSCAN), Ordering points to identify the clustering structure (OPTICS), etc.), a distribution algorithm/model, a centroid algorithm/model, a neural algorithm/model, etc. In some examples, the clustering component 117 can identify/determine/tag certain clusters as non-noisy/relevant/useful/valuable clusters and/or identify/determine/tag other clusters as noisy/non-useful/outliers/non-valuable. For instance, the clustering component 117 can determine that a cluster is non-noisy (e.g., representative/relevant for an attribute/characteristic) if points/representations/data within the cluster are grouped within a predetermined distance to each other (e.g., an average or farthest spacing between points is within a threshold), if points/representations/data within the cluster are within a predetermined distance to a centroid/center or designated center, if points/representations/data within a cluster share more than a predetermined number of attributes, if there are more than a predetermined number of points/representations/data within a cluster, etc. Each cluster can be associated with one or more attributes/characteristics. Data regarding a cluster (e.g., attributes/characteristics for data of a cluster, a shape/distance or other characteristics of a cluster, etc.) can be stored in a clustering datastore 121. Example techniques for generating clusters are discussed below in reference to FIG. 5. In examples, the clustering component 117 can operate in cooperation with the signature processing component 116 to determine/identify a data signature that is similar to a data signature of a point/representation/data in a cluster. Example techniques for identifying a data signature that is similar to a data signature of a cluster are discussed below in reference to FIG. 6.

The metadata analysis component 118 can be configured to generate information/data regarding data under analysis. For example, the metadata analysis component 118 can receive data from the signature processing component 116 and/or the clustering component 117 indicating that data has a threshold amount of similarity to tagged data that is tagged as being associated with an issue. The metadata analysis component 118 can retrieve metadata for the tagged data, wherein the metadata can indicate a category/classification of the issue/threat (e.g., a family of the threat, a type of the threat, etc.), an entity that created the issue/threat (also referred to as “the threat creator”) (e.g., human, group, organization, etc. that can be based on a unique identifier for the entity), an entity that distributed the issue/threat, a time/date when the issue/threat was created/updated, a platform(s) targeted by the issue/threat (e.g., mobile, desktop, type of operating system, etc.), a behavior/function of the issue threat, a method/technique used to propagate/transmit the issue/threat (e.g., downloads, email attachments, etc.), a country/state/nation/political entity of origin of the issue/threat (e.g., a country where the threat was created/distributed), and/or any other characteristic/attribute/feature of the issue/threat. To illustrate, a category/classification of an issue/threat can indicate a particular type/family of malware threat (e.g., a virus, spyware, ransomware, polymorphic malware, a particular type of virus, a particular type of spyware, a particular type of ransomware, a particular type of polymorphic malware, etc.), and so on. The metadata analysis component 118 can retrieve metadata from a datastore associated with the memory 112 and/or another datastore.

In examples, the metadata analysis component 118 can generate/create a message/notification/report that includes or is based on metadata and/or provide/send the message/notification/report to another component/device. In some instances, the message/notification/report can indicate a likelihood/confidence that the data includes an issue/threat and/or a confidence that the metadata being provided accurately depicts the issue/threat. In examples, the message/notification/report indicates if a threat was detected, a type of threat that was detected, a confidence value of a detected threat (e.g., a rating on a scale of 1 to 10 of a confidence that data includes a threat, with 10 (or 1) being the highest confidence that the data includes a threat), where a threat is located in data, a source of a threat, any metadata identified as being associated with the threat, and so on. In the example of FIG. 1, a notification 131 is presented via the interface device 130 indicating that a threat has been detected and providing various details about the threat.

In examples, the metadata analysis component 118 can cause an operation to be performed for a detected issue. For instance, if the security detection component 114 detects a threat and/or a certain type of threat based on metadata associated with the threat, the metadata analysis component 118 can cause an operation to be performed, such as removing the threat from the data, replacing a portion of the data that includes the threat with different data (e.g., malicious data), preventing the threat from associating with the data, and so on. This can include sending an instruction/message to another component to perform the operation. In some examples, an operation is performed based on/in response to user input, such as a user viewing the notification 131 and requesting that the operation be performed, which can include selecting a user interface element.

The security detection component 114, signature generation component 115, signature processing component 116, clustering component 117, and/or metadata analysis component 118 can be implemented in a variety of context across a variety of devices/system. For example, one or more of the security detection component 114, signature generation component 115, signature processing component 116, clustering component 117, and/or metadata analysis component 118 can be implemented at the service provider 110, network device 145, and/or client device 130. In some illustrations, one or more instances of the security detection component 114, signature generation component 115, signature processing component 116, clustering component 117, and/or metadata analysis component 118 are implemented at one or more of the service provider 110, network device 145, and the client device 130. Further, the service provider 110 can include one or more service providers implemented as one or more computing devices, which can collectively or individually implement the security detection component 114, signature generation component 115, signature processing component 116, clustering component 117, and/or metadata analysis component 118. As such, the functionality of security detection component 114, signature generation component 115, signature processing component 116, clustering component 117, and/or metadata analysis component 118 can be divided in a variety of manners across a variety of different devices/systems/components, which may or may not operate in cooperation.

The security detection component 114, signature generation component 115, signature processing component 116, clustering component 117, and/or metadata analysis component 118 can be configured to perform operations at any time. In one example, an evaluation of data is performed in response to a request by the client device 130, such as a user providing input through the client device 130 to analyze data. For instance, a user (not illustrated) can employ the client device 130 to initiate an evaluation of data and the service provider 110 can provide a message back to the client device 130 regarding the evaluation, such as information indicating whether or not a threat was detected, a type of threat detected, and so on. A user can include an end-user, an administrator (e.g., an Information Technology (IT) individual), or any other individual. In another example, an evaluation of data is performed periodically and/or in response to a non-user-based request received by the client device 130, service provider 110, network device 145, and/or another device. In yet another example, an evaluation of data is performed when data is received/sent/downloaded.

The one or more network interfaces 113 can be configured to communicate with one or more devices over a communication network. For example, the one or more network interfaces 113 can send/receive data in a wireless or wired manner over the one or more networks 140, which can include one or more personal area networks (PAN), local area networks (LANs), wide area networks (WANs), Internet area networks (IANs), cellular networks, the Internet, etc. In some examples, the one or more network interfaces 113 can implement a wireless technology, such as Bluetooth, Wi-Fi, near field communication (NFC), or the like.

The data signature datastore 120, clustering datastore 121, and/or any other datastores associated with the memory 112 can be associated with any entity and/or located at any location. In some examples, a datastore is associated with a first entity (e.g., company, environment, etc.) and the service provider 110, network device(s) 145, and/or client device 130 is associated with a second entity that provides a service to evaluate data. For instance, a datastore can be implemented in a cloud environment or locally at a facility to store a variety of forms of data and the service provider 110 can evaluate the data to provide information regarding a potential issue/threat associated with the data. In some examples, a datastore and the service provider 110/network device(s) 145/client device 130 are associated with a same entity and/or located at a same location. As such, although the data signature datastore 120 and clustering datastore 121 are illustrated in the example of FIG. 1 as being located within the memory 112, in some examples the data signature datastore 120 and/or clustering datastore 121 can be included within another device/system.

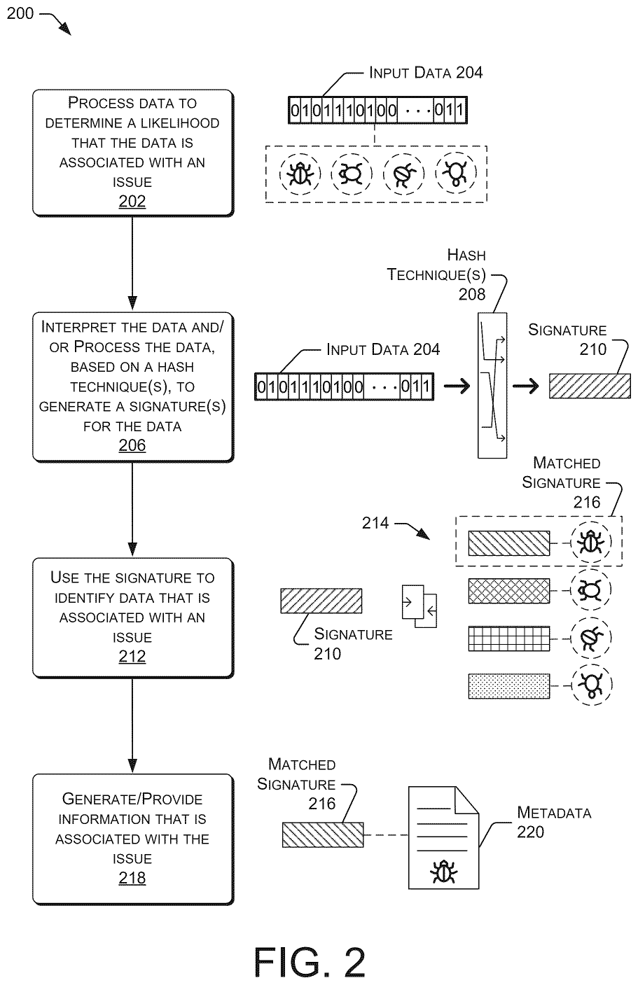

FIGS. 2, 3, 4, 5, and 6 illustrate example processes 200, 300, 400, 500, and 600, respectively, in accordance with one or more examples. For ease of illustration, processes 200, 300, 400, 500, and 600 can be performed in the example architecture 100 of FIG. 1. For example, one or more of the individual operations of the processes 200, 300, 400, 500, and 600 can be performed by the control circuitry 111. However, the processes 200, 300, 400, 500, and 600 can be performed in other architectures. Moreover, the architecture 100 can be used to perform other processes.

The processes 200, 300, 400, 500, and 600 (as well as each process described herein) are each illustrated as a logical flow graph, each graph of which represents a sequence of operations that can be implemented in hardware, software, or a combination thereof. In the context of software, the operations represent executable instructions stored on one or more computer-readable media that, when executed by control circuitry (e.g., one or more processors or other components), perform the recited operations. Generally, executable instructions include routines, programs, objects, components, data structures, and the like that cause particular functions to be performed or implement particular data types. The order in which the operations are described is not intended to be construed as a limitation, and any number of the described operations can be combined in any order and/or in parallel to implement a process. Further, any number of the described operations can be omitted.

FIG. 2 illustrates the example process 200 to detect a potential issue with data (sometime referred to as “input data”) and generate/provide information regarding the issue. Input data can include any data that is received, retrieved, transmitted, obtained, or otherwise identified for processing, analysis, evaluation, etc.

At 202, data can be processed to determine a likelihood that the data is associated with an issue. For example, the control circuitry 111 can receive or retrieve input data 204 from another device/system/component and perform one or more analysis techniques to determine that the input data is associated with an issue (e.g., a likelihood/confidence value exceeds a threshold). In some instances, the one or more analysis techniques include generating an n-dimensional representation for the input data and/or processing the n-dimensional representation with a analysis model to determine if the n-dimensional representation is similar to an n-dimensional representation that is associated with an issue/threat. The input data can comprise a variety of types of data, such as file system data, non-image-based data, image-based data, network traffic data, runtime data, data associated with an isolated environment, or any other data.

At 206, the data can be interpreted and/or processed to generate a signature(s) for the data. The processing can be based on/implement one or more hash-based techniques. For example, in response to or based on determining that the input data 204 is associated with an issue at block 202, the control circuitry 111 can interpret the input data 204 as a predetermined data type (which can be a data type that is not initially associated with the input data 204) and/or process the input data 204 using one or more hash-based techniques 208 to create a signature 210 for the input data 204 (sometimes referred to as a “data fingerprint 210”). The processing can include processing the input data 204 in groups of bits/bytes with each group of bits/bytes including a predetermined number of bits/bytes. A data type can indicate a value, size, format, etc. of data. Example data types include characters, integers, strings, Booleans, floating-points, lists, arrays, numbers, sequences, classes, variables, functions, etc.

At 212, the signature can be used to identify data that is associated with an issue. For example, the control circuitry 111 can compare the signature 210 generated at block 206 with one or more signatures 214 that are labeled as being associated with issues/threats. The comparison can identify a matched signature 216 that includes a threshold amount of similarity to the signature 210. In examples, the control circuitry 111 can compare a band(s) of the signature 210 with a corresponding band(s) of the one or more signatures 214. In examples, the one or more signatures 214 that are associated with issues/threats are associated with one or more clusters/groups. In such examples, the control circuitry 111 can compare the signature 210 to one or more of signatures of the cluster, such as a particular signature that is representative of the cluster, multiple signatures associated with the cluster, a predetermined number of signatures associated with the cluster, etc.

At 218, information that is associated with the issue can be generated and/or provided. For example, the control circuitry 111 can retrieve metadata 220 for the data of the matched signature 216 and/or use the metadata 220 to generate data/information (also referred to as “analysis data/information”) regarding an issue/threat that is associated with the input data 204. The metadata 220 and/or generated data/information can indicate a category/classification of the issue/threat (e.g., a family of the threat, a type of the threat, etc.), an entity that created the issue/threat, an entity that distributed the issue/threat, a time/date when the issue/threat was created/updated, a platform(s) targeted by the issue/threat (e.g., mobile, desktop, type of operating system, etc.), a behavior/function of the issue threat, a method/technique used to propagate/transmit the issue/threat (e.g., downloads, email attachments, etc.), and/or any other characteristic/attribute/feature of the issue/threat. An entity can be identified using an identifier, such as a name, unique value/number, etc. In some cases, the metadata 220 is provided/output as information/potential information about the input data 204, which can provide additional insights about the issue/threat associated with the input data 204.

In one illustration, the process 200 can provide information for data that is associated with an issue. For example, the control circuitry 111 can perform one or more operations of the process 200 to determine that input data likely includes an issue, identify data that is similar to the input data and already classified as being associated with a threat, and/or provide detailed information regarding the threat based on metadata associated with the threat. The information can indicate that the issue with the input data is the threat, a likelihood that the input data is the threat, a characteristic of the threat, etc., which can provide additional insights regarding the issue.

FIG. 3 illustrates the example process 300 to generate a signature for data. In examples, the process 300 is performed as part of block 206 of FIG. 2. However, the process 300 can be performed in other contexts.

At 302, data can be interpreted/processed at a bit/byte level as a predetermined data type. For example, the control circuitry 111 can process/convert/translate data 304 in groups of bits/bytes with a set of bits corresponding to a character and multiple sets of bits corresponding to a word. The control circuitry 111 can identify a first group of bits 306 that includes three bytes of data, with each byte corresponding to a set of bits. As shown, the group of bits 306 includes a set of bits 310 (i.e., a first byte), a set of bits 312 (i.e., a second byte), and a set of bits 314 (i.e., a third byte). The set of bits 310 are directly adjacent to the set of bits 312 and the set of bits 312 are directly adjacent to the set of bits 314. In this example, the control circuitry 111 converts the set of bits 310 to a first character (i.e., the letter “L”), the set of bits 312 to a second character (i.e., the letter “R”), and the set of bits 314 to a third character (i.e., the letter “V”). In this example, each byte of the data 304 forms a character and three characters form a word. That is, a predetermined number of bits/bytes form a character/word. As such, the data 304 (e.g., a file or other data) can be represented with a set of words. In some instances, the words are not part of a vocabulary of a language (e.g., are not understandable in the English language). In a similar manner, the control circuitry 111 can convert/interpret any number of bits/bytes of the data 304 (e.g., group of bites 308, etc.) to form additional characters and/or words. Words can form a character string.

Although the data 304 is interpreted as characters in this example, which can use a character encoding standard (e.g., ASCII, Unicode, etc.), the data 304 can be interpreted as any data type, such as integers, stings, Booleans, floating-points, lists, arrays, numbers, sequences, classes, variables, functions, etc. Further, although the example uses three-character words, the words can include any number of characters.

At 316, a shingling process can be performed. For example, the control circuitry 111 can perform a shingling/k-shingling process that generate/identifies shingles 318 (also referred to as “the set of shingles 318”). The process can include moving a window of length k along the set of words (e.g., character string) to identify shingles. In this example, k is two such that shingles of length two are created. As shown, the shingles can include “LR,” “RV,” “VY,” “YM,” “XQ,” and so on. In some examples, duplicate shingles (e.g., shingle sets) within the shingles 318 are removed and/or the shingles 318 are merged/combined to create a vocabulary for the data 304. After performing the shingling process at block 316, the data 302 can be represented as a set of shingles (i.e., the shingles 318).

At 320, one or more hashing techniques can be performed to generate a signature for the data. For example, the control circuitry 111 can use a hash function to hash the values of the shingles 318 using a length of the vocabulary of the data 304 to convert the shingles 318 from characters into values, such as integers, etc. For example, if there are 100 total pairs of shingles, each shingle can be assigned a value between zero and the length of the vocabulary. The data 302 can be represented with a set of integers. The control circuitry 111 can then perform a minimum hash function (e.g., MinHashing function, also referred to as a “MinHash function”) to convert the integers into a dense representation/vector. The data 302 can now be represented with a set of integers, which can be stored/structured within a vector or another data structure. The set of integers can form a signature 322 for the data 302. In examples, the signature 322 includes a predetermined number of integers, such as 50, 100, 150, 200, etc. Although discussed in the context of integers, other data types can be used for the values of the signature 322.

In examples, a value, such as a character, integer, etc., discussed herein can be stored in a data structures, such as a vector, matrix, etc. Further, various data types can be used, even though specific data types are referenced above/herein.

FIG. 4 illustrates the example process 400 to compare a signature for input data to signatures for data that is associated with an issue/threat and to obtain metadata associated with a matched signature. In examples, the process 400 is performed as part of blocks 212 and/or 218 of FIG. 2. However, the process 400 can be performed in other contexts.

At 402, a signature for input data can be compared to one or more signatures of data that is associated with an issue(s). For example, the control circuitry 111 can compare a signature 404 for input data (also referred to as “data under analysis/evaluation”) to one or more of a plurality of signatures 406 for data that is associated with an issue/threat. The signature 404 and/or the plurality of signatures 406 can be generated through the process 300 and/or another process/technique. The plurality of signatures 406 can be for data that has previously been labeled/tagged as being associated with an issue/threat. The plurality of signatures 406 can be for different issues/threats (e.g., different types of issues/threats). For ease of discussion/illustration, the plurality of signatures 406 is shown with three signatures. However, the plurality of signatures 406 can include any number of signatures. Further, input data can be represented with any number of signatures (e.g., for different portions/sections of the input data, signatures generated with different techniques, etc.), wherein one or more of the signatures for input data can be compared to one or more of the plurality of signatures 406. Although the signatures 404 and 406 are represented with integers as values, the signatures 404 and/or 406 can be represented with any value/data type.

In examples, the control circuitry 111 can perform a band-based comparison, wherein a band of the signature 404 is compared to a corresponding band of one or more of the plurality of signatures 406. Here, a signature can be separated into or represented with a predetermined number of bands, wherein each band can include a predetermined number of values with each value being represented with a predetermined number of bits/bytes. In the example illustrated, band 1 includes values 1-20, an adjacent band 2 includes values 21-40, and so on. However, any number of values can be included in a band.

To illustrate, the control circuitry 111 can compare band 1 of the signature 404 to band 1 of a first signature 406 (i.e., values 1-20 of the first signature 406 to values 1-20 of the first signatures 406), compare band 1 of the signature 404 to band 1 of a second signature 406 (i.e., values 1-20 of the second signature 406), and/or compare band 1 of the signature 404 to band 1 of a third signature 406 (i.e., values 1-20 of the third signature 406), as shown in FIG. 4. The control circuitry 111 can proceed in a similar fashion to compare band 2 of the signature 404 to band 2 of a first signature 406 (i.e., values 21-40 of the first signature 406), compare band 2 of the signature 404 to band 2 of a second signature 406 (i.e., values 21-40 of the second signature 406), and/or compare band 2 of the signature 404 to band 2 of a third signature 406 (i.e., values 21-40 of the third signature 406). The control circuitry 111 can compare any number of bands of the signature 404 to corresponding bands of the signatures 406 in a similar fashion. In the example shown, a comparison of signatures is performed for corresponding bands (e.g., the first bands are compared, the second bands are compared, etc.). However, in some examples, non-corresponding bands can be compared, such as by comparing band 1 of the signatures 404 to each of bands 1, 2, 3, etc. of the signature 406.

In examples, the control circuitry 111 can compare each band of the signature 404 to each of the corresponding bands of the plurality of signatures 406. Further, in examples, the control circuitry 111 can perform a band-by-band comparison that moves onto processing a next band when a previous band does not match. For instance, the control circuitry 111 can compare a first band of the signature 404 with each first band of the plurality of signatures 406. In response to determining that the first band of the signature 404 does not match the first band of any of the plurality of signatures 406, the control circuitry 111 can move onto comparing the second band of the signature 404 to the second band of each of the plurality of signatures 406. Here, the control circuitry 111 can move onto processing a next band when a match is not made for a previous band.

In examples, the signature 404 and one or more of the plurality of signatures 406 can be representative of the same portion/section of data. For example, the signature 404 can be representative of a first predetermined number of bits/bytes of input data and the plurality of signatures 406 can be representative of the first predetermined number of bits/bytes of data associated with an issue/threat. As such, a comparison of, for example, band 1 of the signature 404 to band 1 of a signature 406 can be a comparison of the same portion/section.

At 408, a signature(s) that satisfies one or more criteria can be determined/identified based on the comparison. For example, based on the comparison at block 402, the control circuitry 111 can identify/determine one or more signatures of the plurality of signatures 406 that satisfy one or more criteria. In examples, a signature of the signatures 406 can satisfy one or more criteria if a predetermined/threshold number of bands/values of the signature 404 and the signature 406 match. A match can refer to the same values and/or a threshold amount of similarity between values. For example, a first signatures 406 can be referred to as a matched signature to the signature 404 if a first band of the first signature 406 and a first band of the signature 404 have the same values and/or if values of the first band of the first signature 406 and values of the first band of the signature 404 have a threshold amount of similarity to each other (e.g., if the values are integers, the integers are within a threshold number of each other). A matched signature of the plurality of signatures 406 and/or the signature 404 can be considered a candidate pair or nearest neighbor. The control circuitry 111 can identify any number of candidate pairs and/or rank the candidate pairs based on a similarity to the signature 404.

In examples, the control circuitry 111 can perform processing to identify a matched signature(s) (e.g., the operations of blocks 402 and/or 408) and cease/stop the processing when a predetermined number of bands match for the signature 406. For instance, if the first two bands of the signature 404 match the first two bands of a first signature 406, the control circuitry 111 can identify a match and refrain from comparing other bands of the signatures 404 and 406. Further, in examples, the control circuitry 111 can perform the processing and cease/stop the processing when a predetermined number of matched signatures are identified/found. Moreover, in examples, the control circuitry 111 can perform the processing until the signature 404 is compared to each of the signatures 406 and/or until the signature 404 is compared to a predetermined number of the signatures 406.

Although various examples discuss comparing signatures band-by-band, in examples any number of values can be compared between signatures within or outside the context of bands. For instance, a first signature can be compared to a second signature by comparing a first value of the first signature with a first value of the second signature, a second value of the first signature with a second value of the second signature, and so on.

At 410, metadata for data associated with a matched signature(s) can be retrieved/obtained. For example, the control circuitry 111 can obtain/retrieve metadata 412 for data that is associated with any of the signatures 406 that match the signature 404 (e.g., any candidate pairs that match by a threshold amount). Additionally, or alternatively, the control circuitry 111 can obtain/retrieve the data that is associated with any matched signatures, such as to analyze the data to generate additional metadata.

In examples, the control circuitry 111 can use metadata 412 and/or any generated metadata to generate data/information regarding an issue/threat that is associated with the input data. The data/information (e.g., analysis data) can indicate a category/classification of the issue/threat (e.g., a family of the threat, a type of the threat, etc.), an entity that created the issue/threat (e.g., human, group, organization, etc.), an entity that distributed the issue/threat, a time/date when the issue/threat was created/updated, a platform(s) targeted by the issue/threat (e.g., mobile, desktop, type of operating system, etc.), a behavior/function of the issue threat, a method/technique used to propagate/transmit the issue/threat (e.g., downloads, email attachments, etc.), and/or any other characteristic of the issue/threat. In some cases, the data/information is provided/output in a message/notification/report (e.g., displayed, provided to a component/system, etc.) to inform a user/system about the issue/threat, which can provide insights/details into the issue/threat. In some cases, matched signatures are ranked based on a similarity to the signature 404 (e.g., based on a number of bands/values that match) and/or a ranking is provided/output with the data/information. In some cases, a similarity score of a matched signature to the signature 404 is provided/output with the data/information of the message/notification/report.

As such, in examples, the control circuitry 111 can provide intelligent information about a potential issue/threat associated with input data. For instance, since the plurality of signatures 406 represent different issues/threats (e.g., different types of issues/threats), the control circuitry 111 can identify an issue/threat that is similar to an issue/threat of the input data and/or provide intelligent information about the issue/threat of the input data.

FIG. 5 illustrates the example process 500 to generate clusters for data items and classify the clusters. In examples, the process 500 can be performed at pre-processing/training, such as before runtime/analysis of input data. However, the process 500 can be performed at runtime or any other time. For ease of discussion in referring to multiple pieces of data, the term “data item” may be used in various examples. A data item can refer to any data.

At 502, multiple data items can be processed, based on characteristics/attributes of the data items, to cluster/group the data items. For example, the control circuitry 111 can process data items that are tagged/labeled as being associated with an issue/threat to group/cluster the data items into multiple groups/clusters. The control circuitry 111 can analyze/compare/process attributes/characteristics of the data items to group/cluster the data items, such that data items that have one or more similar/same attributes/characteristics are clustered/grouped in the same group/cluster in an n-dimensional space. The control circuitry 111 can use a clustering algorithm/technique, such as a density-based clustering algorithm/model (e.g., Density-based spatial clustering of applications with noise (DBSCAN), Ordering points to identify the clustering structure (OPTICS), etc.), a distribution algorithm/model, a centroid algorithm/model, a neural algorithm/model, etc. The clustering algorithm/technique can be performed one or more times on the same data items to further refine/update the clusters/groups. In examples, a data item is labeled as part of a cluster if the data item is within a threshold distance to a designated center/centroid of the cluster.

At 504, noisy and/or non-noisy clusters/groups can be determined/identified. For example, the control circuitry 111 can identify clusters/groups of data items that are useful/non-noisy and/or cluster/groups that are noisy/non-useful. To illustrate, the control circuitry 111 can determine that a cluster is non-noisy (e.g., representative/relevant for an attribute/characteristic) if data items within the cluster are grouped within a predetermined distance to each other (e.g., an average or farthest spacing between points is within a threshold), if more than a certain percentage of the data items in the cluster have a same characteristic(s)/attribute(s), if the data items within the cluster share more than a predetermined number of characteristics/attributes, if the data items within the cluster are within a predetermined distance to a centroid/center or designated data item, if there are more than a predetermined number of data items within a cluster, etc. In contrast, the control circuitry 111 can determine that a cluster is noisy (e.g., not representative/relevant for an attribute/characteristic) if data items are grouped outside a predetermined distance to each other (e.g., an average or farthest spacing between points is outside a threshold), if the data items do not share more than a predetermined number of characteristics/attributes, if the data items are outside a predetermined distance to a centroid/center or designated data item, if there are less than a predetermined number of data items within a region, etc. In examples, a non-noisy cluster can exhibit a well-defined structure or pattern of data items and/or includes a relatively dense grouping (e.g., more than a threshold), whereas a noisy cluster lacks a well-define structure or pattern and/or includes a relatively sparse/scattered grouping (e.g., less than a threshold). Noisy and/or non-noisy clusters/data items can be tagged/labeled as such.

At 506, a common characteristic(s)/attribute(s) for each cluster/group can be determined/identified. For example, the control circuitry 111 can determine/identify, for each cluster/group, a characteristic(s)/attribute(s) that is shared by more than a threshold number of data items in the cluster/group. The characteristic/attribute can include a category/classification of the issue/threat (e.g., a family of the threat, a type of the threat, etc.), an entity that created the issue/threat, an entity that distributed the issue/threat, a time/date when the issue/threat was created/updated, a platform(s) targeted by the issue/threat (e.g., mobile, desktop, type of operating system, etc.), a behavior/function of the issue threat, a method/technique used to propagate/transmit the issue/threat (e.g., downloads, email attachments, etc.), a country/state/nation/political entity of origin of the issue/threat (e.g., a country where the threat was created/distributed), and/or any other characteristic/attribute/feature of the issue/threat.

At 508, each cluster/group can be labeled and/or associated with metadata. For example, the control circuitry 111 can associate each cluster/group with a common characteristic(s)/attribute(s) that is identified at block 506 and/or label each cluster/group with a name/identifier representative of the cluster, such as a name/identifier that indicates a common characteristic/attribute. As such, metadata for the cluster can indicate the characteristic(s)/attribute(s) that is shared for the cluster and/or name/identifier for the cluster. In examples, the control circuitry 111 generates a signature(s) for a data item(s) of a cluster, such as by using any of the techniques discussed herein for generating a signature. The signature can be associated with the cluster (e.g., stored in metadata for the cluster).

In some examples, one or more of the operations of the process 500 are performed automatically by a system/component (e.g., one or more of blocks 502-508 are performed by a system/component). However, one or more of the operations of the process 500 can be performed by a user.

FIG. 6 illustrates the example process 600 to compare a signature for input data to signatures associated with a cluster and to obtain metadata associated with a matched signature. In examples, the process 600 is performed as part of blocks 212 and/or 218 of FIG. 2. Further, in examples, the process 600 is performed based on cluster/groups that are formed through the process 500 of FIG. 5. Moreover, in examples, the process 600 is performed at runtime, such as to evaluate input data. However, the process 600 can be performed in other contexts.

At 602, a signature for input data can be compared to one or more signatures of data that are associated with a cluster(s)/group(s). For example, the control circuitry 111 can compare a signature 604 for input data (also referred to as “data under analysis/evaluation”) to one or more signatures 606 that are associated with a plurality of clusters 608, respectively. Each of the clusters 608 can be associated with an issue/threat, such as one or more different characteristics/attributes of an issue/threat. In examples, the clusters 608 represent non-noisy/useful clusters. The signatures 604 and/or 606 can be generated through any of the signature generation techniques discussed herein and/or another technique.

In examples, the control circuitry 111 compares the signature 604 to a predetermined number of signatures of data associated with the cluster, such as a signature for each data item in a cluster, signatures of more than a threshold number of data items of a cluster, etc. Further, in examples, the control circuitry 111 compares the signature 604 to a particular signature(s) of a cluster, such as a representative signature for the cluster, which can be stored/designated in metadata for the cluster. A representative signature for the cluster can include a signature(s) for a data item that is within a center region/centroid of the cluster, a signature(s) for a data item that is within a predetermined distance to a center/centroid of the cluster, a signature for a data item that is located within an exterior band/portion of the cluster, etc.

For ease of discussion/illustration, the plurality of signatures 606 and the plurality of clusters are shown with three signatures and cluster, respectively. However, any number of clusters and/or signatures can be implemented. Further, input data can be represented with any number of signatures (e.g., for different portions/sections of the input data, signatures generated with different techniques, etc.), wherein one or more of the signatures for input data can be compared to one or more of the plurality of signatures 606. Although the signatures 604 and 606 are represented with integers as values, the signatures 604 and/or 606 can be represented with any value/data type.

At 610, a signature(s) that satisfies one or more criteria can be determined/identified based on the comparison. For example, based on the comparison at block 602, the control circuitry 111 can identify/determine one or more signatures of the plurality of signatures 606 that satisfy one or more criteria. In examples, a signature 606 can satisfy one or more criteria if a predetermined/threshold number of bands/values of the signature 604 and the signature 606 match (e.g., have the same value or are similar within a threshold amount).

In some examples, the control circuitry 111 can perform one or more operations of blocks 402 and/or 408 of FIG. 4 at blocks 602 and 610 of FIG. 6. For instance, the control circuitry can perform a band-based comparison, wherein a band(s) of the signature 604 is compared to a corresponding band of one or more of the plurality of signatures 606.

At 612, metadata for data associated with a matched signature(s) can be retrieved/obtained. For example, the control circuitry 111 can obtain/retrieve metadata 614 for a cluster (from among the clusters 608) that is associated with a matched signature. In many examples, the metadata 614 is associated with the cluster as representative metadata for the cluster. However, the metadata 614 can be associated with the specific data of the matched signature. Additionally, or alternatively, the control circuitry 111 can obtain/retrieve data that is associated with a matched signature, such as to analyze the data to generate additional metadata.

In examples, the control circuitry 111 can use metadata 614 and/or any generated metadata to generate data/information regarding an issue/threat that is associated with the input data. The data/information (e.g., analysis data) can indicate a category/classification of the issue/threat (e.g., a family of the threat, a type of the threat, etc.), an entity that created the issue/threat (e.g., human, group, organization, etc.), an entity that distributed the issue/threat, a time/date when the issue/threat was created/updated, a platform(s) targeted by the issue/threat (e.g., mobile, desktop, type of operating system, etc.), a behavior/function of the issue threat, a method/technique used to propagate/transmit the issue/threat (e.g., downloads, email attachments, etc.), and/or any other characteristic of the issue/threat. In some cases, the data/information is provided/output in a message/notification/report (e.g., displayed, provided to a component/system, etc.) to inform a user/system about the issue/threat, which can provide insights/details into the issue/threat. In some cases, matched signatures are ranked based on a similarity to the signature 604 (e.g., based on a number of bands/values that match) and/or a ranking is provided/output with the data/information. In some cases, a similarity score of a matched signature to the signature 604 is provided/output with the data/information of the message/notification/report.

As such, in examples, the control circuitry 111 can provide intelligent information about a potential issue/threat associated with the input data. For instance, since the plurality of clusters 608 represent different issues/threats (e.g., different types of issues/threats), the control circuitry 111 can identify an issue/threat that is similar to an issue/threat of the input data (based on an analysis of the input data relative to a cluster) and/or provide intelligent information about the issue/threat of the input data.

In some examples, the processes 400 and 600 are both performed to determine one or more data items that are similar to input data and/or identify metadata. In other examples, one of the processes 400 and 600 is performed.

The above description of examples of the disclosure is not intended to be exhaustive or to limit the disclosure to the precise form disclosed above. While specific examples are described above for illustrative purposes, various equivalent modifications are possible within the scope of the disclosure, as those skilled in the relevant art will recognize. For example, while processes or blocks are presented in a given order, alternative examples can perform routines having steps, or employ systems having blocks, in a different order, and/or some processes or blocks can be deleted, moved, added, subdivided, combined, and/or modified. Each of these processes or blocks can be implemented in a variety of different ways. Also, while processes or blocks are at times shown as being performed in series, these processes or blocks can instead be performed in parallel and/or at different times.

Certain ordinal terms (e.g., “first” or “second”) can be provided for ease of reference and do not necessarily imply physical characteristics or ordering. Therefore, an ordinal term (e.g., “first,” “second,” “third,” etc.) used to modify an element, such as a structure, a component, an operation, etc., does not necessarily indicate priority or order of the element with respect to any other element, but rather can generally distinguish the element from another element having a similar or identical name (but for use of the ordinal term). In addition, articles (“a” and “an”) can indicate “one or more” rather than “one.” Further, an operation performed “based on” a condition or event can also be performed based on one or more other conditions or events not explicitly recited. In some contexts, description of an operation or event as occurring or being performed “based on,” or “based at least in part on,” a stated event or condition can be interpreted as being triggered by or performed in response to the stated event or condition.

With respect to the various methods and processes disclosed herein, although certain orders of operations or steps are illustrated and/or described, various steps and operations shown and described can be performed in any suitable or desirable temporal order. Furthermore, any of the illustrated and/or described operations or steps can be omitted from any given method or process, and the illustrated/described methods and processes can include additional operations or steps not explicitly illustrated or described.

In the above description, various features are sometimes grouped together in a single example, figure, or description thereof for the purpose of streamlining the disclosure and/or aiding in the understanding of one or more of the various aspects of the disclosure. This method of disclosure, however, is not to be interpreted as reflecting an intention that any claim require more features than are expressly recited in that claim. Moreover, any components, features, or steps illustrated and/or described in a particular example herein can be applied to or used with any other example(s). Further, the scope of the disclosure should not be limited by the particular examples described above.

One or more examples have been described above with the aid of method steps illustrating the performance of specified functions and relationships thereof. The boundaries and/or sequence of these functional building blocks and method steps have been defined herein for convenience of description. Alternate boundaries and sequences can be defined so long as the specified functions and relationships are appropriately performed. Any such alternate boundaries or sequences are thus within the scope and spirit of the disclosure.

To the extent used, flow diagram block boundaries and/or sequence can be defined otherwise and still perform the certain significant functionality. Such alternate definitions of both functional building blocks and flow diagram blocks and sequences are thus within the scope and spirit of the disclosure. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more examples are used herein to illustrate one or more aspects, one or more features, and/or one or more concepts. A physical example of an apparatus, an article of manufacture, a machine, and/or of a process can include one or more of the aspects, features, concepts, examples, etc. described with reference to one or more of the examples discussed herein. Further, from figure to figure, the examples can incorporate the same or similarly named functions, steps, modules, etc. that can use the same, related, or unrelated reference numbers. The relevant features, elements, functions, operations, modules, etc. can be the same or similar functions or can be unrelated.

The term “module” or “component” can be used in the description of one or more of the examples. A module or component can implement one or more functions via a device, such as a processor or other processing device or other hardware that can include or operate in association with a memory that stores operational instructions. A module or component can operate independently and/or in conjunction with software and/or firmware. A module/component can include one or more sub-modules/components, each of which can be one or more modules/components.

A computer readable memory can include one or more memory elements. A memory element can be a separate memory device, multiple memory devices, or a set of memory locations within a memory device. Such a memory device can be a read-only memory, random access memory, volatile memory, non-volatile memory, static memory, dynamic memory, flash memory, cache memory, and/or any device that stores digital information. The memory device can be in a form of a solid-state memory, a hard drive memory, cloud memory, thumb drive, server memory, computing device memory, and/or other physical medium for storing digital information.

### ADDITIONAL EXAMPLES

Example 1. A method comprising: processing input data to determine that the data is associated with a potential threat; interpreting the input data as a predetermined data type; processing the input data using locality sensitive hashing to create a signature for the input data, the processing including processing the input data in groups of bytes with each group of bytes including a predetermined number of bytes; comparing the signature to a plurality of signatures that are associated with one or more threats, the comparing including: comparing a first band of the signature with a first band of each of the plurality of signatures; and comparing a second band of the signature with a second band of each of the plurality of signatures; based on the comparing, determining a first matched signature from among the plurality of signatures that is similar to the signature; identifying first threat data that is associated with the first matched signature; retrieving first metadata for the first threat data, the first metadata indicating at least one of a category of the potential threat, an entity that created the potential threat, an entity that distributed the potential threat, a time when the potential threat was created, a platform targeted by the potential threat, a behavior of the potential threat, or a method used to propagate the potential threat; and based on the first metadata, providing information indicating that the input data is associated with the first metadata.

Example 2. The method of any examples discussed herein, including example 1, wherein the signature for the data includes a predetermined number of values.

Example 3. The method of any examples discussed herein, including example 1, wherein the input data is binary data.

Example 4. The method of any examples discussed herein, including example 1, further comprising: determining that the first band of the signature does not match the first band of each of the plurality of signatures; wherein the comparing the second band of the signature with the second band of each of the plurality of signatures is performed in response to determining that the first band of the signature does not match the first band of each of the plurality of signatures.

Example 5. The method of any examples discussed herein, including example 1, further comprising: based on the comparing, determining a second matched signature from among the plurality of signatures that is similar to the signature; identifying second threat data that is associated with the second matched signature; and retrieving second metadata for the second threat data; wherein the information is based on the second metadata.

Example 6. The method of any examples discussed herein, including example 1, wherein the first band includes a predetermined number of values in the signature.

Example 7. The method of any examples discussed herein, including example 1, wherein the predetermined data type is a character.

Example 8. The method of any examples discussed herein, including example 1, wherein the input data is initially formatted as a non-character data type.

Example 9. A system comprising: one or more processors; and memory communicatively coupled to the one or more processors and storing executable instructions that, when executed by the one or more processors, cause the one or more processors to perform operations comprising: identifying data that is associated with a potential issue; processing the data using a hash-based technique to create a signature for the data, the processing including processing the data in groups of bytes with each group of bytes including a predetermined number of bytes; comparing the signature to a signature for data that is labeled as being associated with an issue; determining a matched signature based on the comparing; retrieving metadata for the signature for the data that is labeled as being associated with the issue, the metadata indicating a characteristic of the issue; and providing analysis data indicating that the data is associated with the characteristic.

Example 10. The system of any examples discussed herein, including example 9, wherein the comparing includes comparing a predetermined number of bands of the signature with a predetermined number of bands of the signature for the data that is labeled as being associated with the issue.

Example 11. The system of any examples discussed herein, including example 10, wherein each band includes a predetermined number of values.

Example 12. The system of any examples discussed herein, including example 9, wherein the processing the data includes processing the data as a predetermined data type.

Example 13. The system of any examples discussed herein, including example 12, wherein the predetermined data type is a character.

Example 14. The system of any examples discussed herein, including example 13, wherein the data is initially formatted as a non-character data type.

Example 15. A system comprising: one or more processors; and memory communicatively coupled to the one or more processors and storing executable instructions that, when executed by the one or more processors, cause the one or more processors to perform operations comprising: processing input data to determine that the data is associated with a potential issue; interpreting the input data as a predetermined data type; processing the input data using locality sensitive hashing to create a signature for the input data, the processing including processing the input data in groups of bytes with each group of bytes including a predetermined number of bytes; comparing the signature to at least one signature associated with each cluster from among a plurality of clusters, each of the plurality of clusters being associated with a threat that shares at least one attribute; based on the comparing, determining a first cluster, from among the plurality of clusters, to which the signature matches; retrieving first metadata for the first cluster, the first metadata indicating at least one of a category of the threat, an entity that created the threat, an entity that distributed the threat, a time when the threat was created, a platform targeted by the threat, a behavior of the threat, or a method used to propagate the threat; and based on the first metadata, providing information indicating that the input data is associated with the first metadata.

Example 16. The system of any examples discussed herein, including example 15, wherein the input data is initially formatted as a non-character data type.

Example 17. The system of any examples discussed herein, including example 15, wherein the predetermined data type is a character.

Example 18. The system of any examples discussed herein, including example 15, wherein the operations further comprise: using a clustering technique to group one or more data items into the first cluster, the one or more data items being associated with the at least one attribute.

Example 19. The system of any examples discussed herein, including example 15, wherein the at least one signature associated with the first cluster is a signature for a data item located at a center region of the first cluster.

Example 20. The system of any examples discussed herein, including example 15, wherein the first metadata is associated with each data item of the first cluster.

What is claimed is:

1. A method comprising:
processing input data to determine that the data is associated with a potential threat;
interpreting the input data as a predetermined data type;
processing the input data using locality sensitive hashing to create a signature for the input data, the processing including processing the input data in groups of bytes with each group of bytes including a predetermined number of bytes;
comparing the signature to a plurality of signatures that are associated with one or more threats, the comparing including:
comparing a first band of the signature with a first band of each of the plurality of signatures; and
comparing a second band of the signature with a second band of each of the plurality of signatures;
based on the comparing, determining a first matched signature from among the plurality of signatures that is similar to the signature;
identifying first threat data that is associated with the first matched signature;
retrieving first metadata for the first threat data, the first metadata indicating at least one of a category of the potential threat, an entity that created the potential threat, an entity that distributed the potential threat, a time when the potential threat was created, a platform targeted by the potential threat, a behavior of the potential threat, or a method used to propagate the potential threat; and
based on the first metadata, providing information indicating that the input data is associated with the first metadata.

2. The method of claim 1, wherein the signature includes a predetermined number of values.

3. The method of claim 1, wherein the input data is binary data.

4. The method of claim 1, further comprising:
determining that the first band of the signature does not match the first band of each of the plurality of signatures;
wherein the comparing the second band of the signature with the second band of each of the plurality of signatures is performed in response to determining that the first band of the signature does not match the first band of each of the plurality of signatures.

5. The method of claim 1, further comprising:
based on the comparing, determining a second matched signature from among the plurality of signatures that is similar to the signature;
identifying second threat data that is associated with the second matched signature; and
retrieving second metadata for the second threat data;
wherein the information is based on the second metadata.

6. The method of claim 1, wherein the first band includes a predetermined number of values in the signature.

7. The method of claim 1, wherein the predetermined data type is a character.

8. The method of claim 1, wherein the input data is initially formatted as a non-character data type.

9. A system comprising:
one or more processors; and
memory communicatively coupled to the one or more processors and storing executable instructions that, when executed by the one or more processors, cause the one or more processors to perform operations comprising:
identifying data that is associated with a potential issue;
processing the data using a hash-based technique to create a signature for the data, the processing including processing the data in groups of bytes with each group of bytes including a predetermined number of bytes;
comparing the signature to a signature for data that is labeled as being associated with an issue;
determining a matched signature based on the comparing;
retrieving metadata for the signature for the data that is labeled as being associated with the issue, the metadata indicating a characteristic of the issue; and
providing analysis data indicating that the data is associated with the characteristic.

10. The system of claim 9, wherein the comparing includes comparing a predetermined number of bands of the signature with a predetermined number of bands of the signature for the data that is labeled as being associated with the issue.

11. The system of claim 10, wherein each band includes a predetermined number of values.

12. The system of claim 9, wherein the processing the data includes processing the data as a predetermined data type.

13. The system of claim 12, wherein the predetermined data type is a character.

14. The system of claim 13, wherein the data is initially formatted as a non-character data type.

15. A system comprising:
one or more processors; and
memory communicatively coupled to the one or more processors and storing executable instructions that, when executed by the one or more processors, cause the one or more processors to perform operations comprising:
processing input data to determine that the data is associated with a potential issue;
interpreting the input data as a predetermined data type;
processing the input data using locality sensitive hashing to create a signature for the input data, the processing including processing the input data in groups of bytes with each group of bytes including a predetermined number of bytes;
comparing the signature to at least one signature associated with each cluster from among a plurality of clusters, each of the plurality of clusters being associated with a threat that shares at least one attribute;
based on the comparing, determining a first cluster, from among the plurality of clusters, to which the signature matches;
retrieving first metadata for the first cluster, the first metadata indicating at least one of a category of the threat, an entity that created the threat, an entity that distributed the threat, a time when the threat was created, a platform targeted by the threat, a behavior of the threat, or a method used to propagate the threat; and
based on the first metadata, providing information indicating that the input data is associated with the first metadata.

16. The system of claim 15, wherein the input data is initially formatted as a non-character data type.

17. The system of claim 15, wherein the predetermined data type is a character.

18. The system of claim 15, wherein the operations further comprise:
using a clustering technique to group one or more data items into the first cluster, the one or more data items being associated with the at least one attribute.

19. The system of claim 15, wherein the at least one signature associated with the first cluster is a signature for a data item located at a center region of the first cluster.

20. The system of claim 15, wherein the first metadata is associated with each data item of the first cluster.
